(19) United States
(12) Patent Application Publication
(10) Pub. No.: US 2020/0223260 A1
(43) Pub. Date: Jul. 16, 2020

(54) NON-PNEUMATIC WHEEL AND HUB

(71) Applicant: COMPAGNIE GENERALE DES ETABLISSEMENTS MICHELIN, CLERMONT-FERRAND (FR)

(72) Inventors: Antonio Delfino, Givisiez (CH); Philippe Berguerand, Givisiez (CH); Pascal Schroeter, Givisiez (CH); Daniel Walser, Givisiez (CH); Gerard Baumgartner, Givisiez (CH)

(21) Appl. No.: 16/472,730

(22) PCT Filed: Dec. 22, 2016
(86) PCT No.: PCT/IB2016/057953

§ 371 Date: Jun. 21, 2019

(51) Int. Cl. B60C 7/24; B60C 7/18; B60B 3/00; B60B 9/04

(52) U.S. Cl. CPC B60C 7/24; B60C 7/18; B60C 2007/146; B60B 9/04; B60B 3/005

(57) ABSTRACT

A hub (300) for a non-pneumatic wheel (102) and the non-pneumatic wheel (102) incorporating such hub (300). The hub (300) includes an annular receiver (302) with a plurality of projections (312) and grooves (318) arranged in an alternating manner along the circumferential direction of the hub (300). The grooves (318) are configured to receive tension-transmitting elements or spokes (106) of the non-pneumatic wheel (102). The annular receiver (302) may be manufactured from a single sheet of metal that ₂ is folded and welded to create the projections (312) and grooves (318).

### FIELD OF THE INVENTION

The subject matter of the present disclosure relates generally to a non-pneumatic wheel and a hub for the non-pneumatic wheel.

### BACKGROUND OF THE INVENTION

Non-pneumatic wheel constructions and their benefits are described in e.g., U.S. Pat. Nos. 6,769465; 6,994,134; 7,013,939; and 7,201,194, which are incorporated herein by reference in their entirety for all purposes. Some non-pneumatic tire constructions propose incorporating an annular band, sometimes referred to as e.g., a shear band, annular shear band, a band with a shear layer, or a compliant band. Embodiments of such are described in e.g., U.S. Pat. Nos. 6,769,465 and 7,201,194. Such non-pneumatic tires provide advantages in tire performance without relying upon a gas inflation pressure for support of the loads applied to the tire.

In one example of a non-pneumatic wheel, a compliant band with a ground contacting portion can be connected with a plurality of tension-transmitting, web-like elements (i.e. spokes) extending radially outward from a center element or hub. As such non-pneumatic wheel rolls over the ground surface, the tension-transmitting elements opposite the ground contacting portion of the wheel support the hub in tension. Specifically, the hub is suspended from the top of the wheel by the spokes instead of being primarily supported by compression of such elements located between the hub and the ground surface as is typical of e.g., solid wheel constructions where a hub is encircled by solid rubber or layers of rubber.

For certain constructions, such non-pneumatic wheel may be formed by open cast molding in which a polymeric material such as e.g., polyurethane is poured into a mold that forms all or part of the non-pneumatic tire. One or more inextensible reinforcement structures such as cords may be molded in place in the compliant band. Typically, in such prior constructions, the spokes and the huh arc molded as an integral, single-piece construction. Alternatively, the spokes may be integrally joined by, a band that is then joined with a hub or wheel center. In either construction, the spokes are not readily removable from either the radially-outer end attached with the compliant hand or the radially-inner end attached to the hub or wheel center.

The construction and configuration of the spokes can affect the performance of the non-pneumatic wheel. Spokes constructed from different sizes, configurations, and materials of construction can affect the way tension is transmitted between the wheel hub and the compliant band, leading to differences in load carrying capabilities of the non-pneumatic wheel and perceived handling characteristics. The density of the spokes can also determine e.g., how much tension each spoke carries as it rotates to the top of the wheel during operation.

Because of e.g., the integral construction, prior non-pneumatic wheel constructions are not readily amenable to substituting different spokes into the non-pneumatic wheel, substituting differed hubs into the non-pneumatic wheel, or both. Such a substitution would require e.g, destructive steps to cut or extricate the spoke from the annular band of the non-pneumatic wheel. Additionally, because the spokes are joined or attached with the wheel hub, the substitution of different wheels hubs of different materials or configuration is not readily feasible for the same reason. Finally, prior manufacturing methods have not been conducive to incorporating reinforcements, shapes, layers of material, and other features into the construction of the spoke.

Accordingly, a hub for a non-pneumatic wheel that allows spokes to he removably attached to the hub would he useful. Such a hub that can be, in certain exemplary embodiments, be readily manufactured would be particularly beneficial. Such a hub that can be used for a variety of different wheel sizes would be also be useful. A non-pneumatic wheel incorporating such a hub would also be useful.

### SUMMARY OF THE INVENTION

The present invention provides a hub for a non-pneumatic wheel. The huh includes an annular receiver with a plurality of projections and grooves arranged in an alternating manner along the circumferential direction of the hub. The grooves are configured to receive tension-transmitting elements or spokes of the non-pneumatic wheel. In certain embodiments, the annular receiver can be readily manufactured from a single sheet of metal that is folded and welded to create the projections and grooves. Additional aspects and advantages of the invention will be set forth in part in the following description, or may be obvious from the description, or may be learned through practice of the invention.

In one exemplary embodiment of the present invention, a hub for a non pneumatic wheel having a plurality of tension-transmitting spokes is provided. The hub defines axial, radial, and circumferential directions. The hub includes a central portion configured for supporting the wheel on a vehicle. An annular receiver is supported on the central portion and extends circumferentially around the central portion. The annular receiver includes a plurality of projections spaced apart from each other along the circumferential direction. Each projection has a longitudinal axis extending along the axial direction. A plurality of grooves are spaced apart from each other along the circumferential direction. Each groove is positioned between a pair of the plurality of projections. Each groove has a longitudinal axis extending along the axial direction. Each groove is configured for the receipt of at least one radially-inner end of one or more of spokes.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of an exemplary embodiment of a non-pneumatic wheel of the present invention.

FIG. 2 illustrates a side view of the exemplary embodiment of FIG. 1.

FIG. 3 is a perspective view of an exemplary tire of the present invention as may be used in the exemplary wheel of FIG. 1.

FIG. 4 is a perspective view of an exemplary wheel hub of the present invention.

FIG. 5 is a side view of the exemplary hub of FIG. 4.

FIG. 6 is an end view of the exemplary hub of FIGS. 4 and 5.

FIG. 7 is a close-up of an exemplary portion of the annular receiver of the hub in FIGS. 4, 5, and 6.

FIGS. 8 and 9 are perspective views of exemplary spokes for tension-transmitting elements) of the present invention.

FIG. 10 is a view of an exemplary groove of the present invention as viewed along a radially inward direction depicted by lines 10-10 in FIG. 2.

The use of the same or similar reference numerals in the figures denotes the same or similar features.

### DETAILED DESCRIPTION OF THE INVENTION

For purposes of describing the invention, reference now will be made in detail to embodiments and aspects of the invention, one or more examples of which are illustrated in the drawings. Each example is provided by way of explanation of the invention, not limitation of the invention. In fact, from the teachings disclosed herein, it will be apparent to those skilled in the art that various modifications and variations can be made in the present invention without departing from the scope or spirit of the invention. For instance, features illustrated or described as part of one embodiment, can be used with another embodiment to yield a still further embodiment. Thus, it is intended that the present invention covers such modifications and variations as come within the scope of the appended claims and their equivalents.

As used herein, the following definitions apply.

Axial direction A refers to a direction parallel to an axis about which a referenced exemplary wheel or tire rotates during use.

Radial direction R refers to a direction perpendicular to axial direction A with radially-outer or radially outward referring to a general direction away from axial direction A, and radially-inner or radially inward referring to a general direction towards axial direction A.

Circumferential direction C refers to a direction defined by defined by the circumference of the wheel or tire, or the direction of rotation the wheel or tire about an axis.

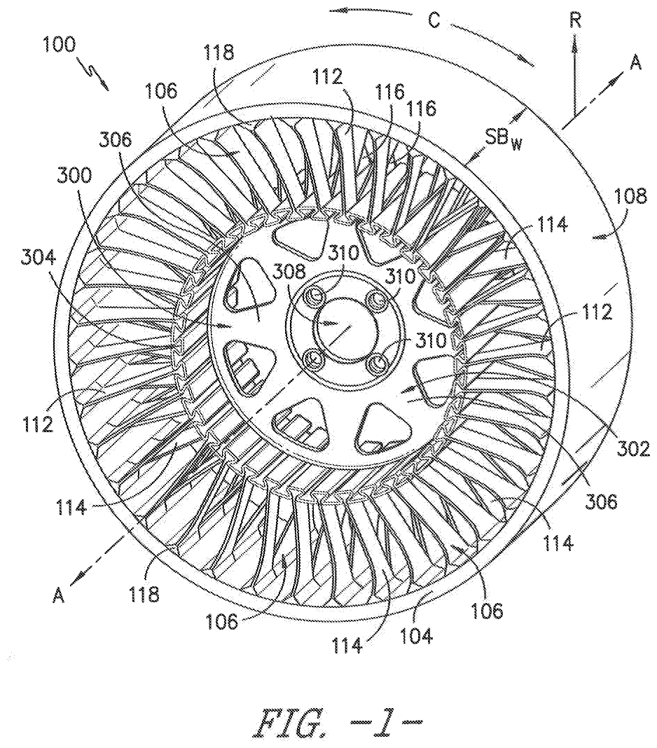

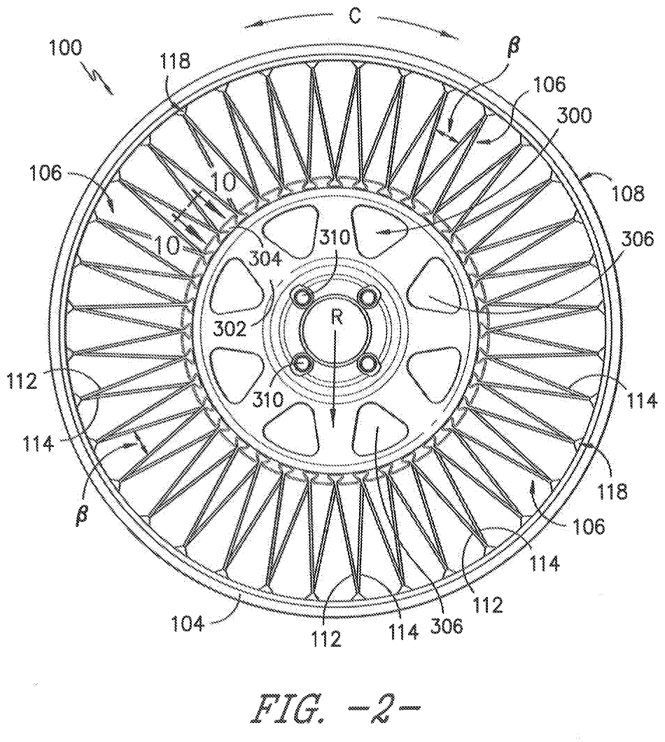

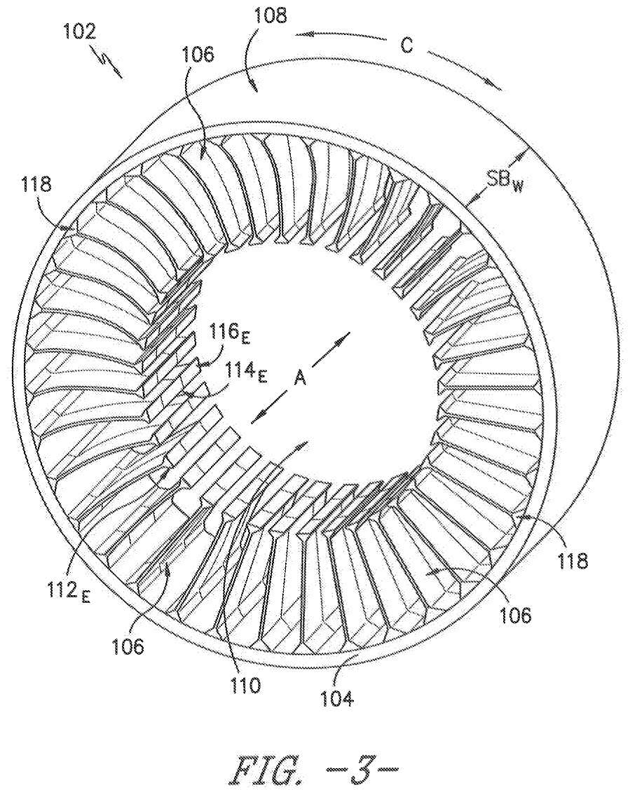

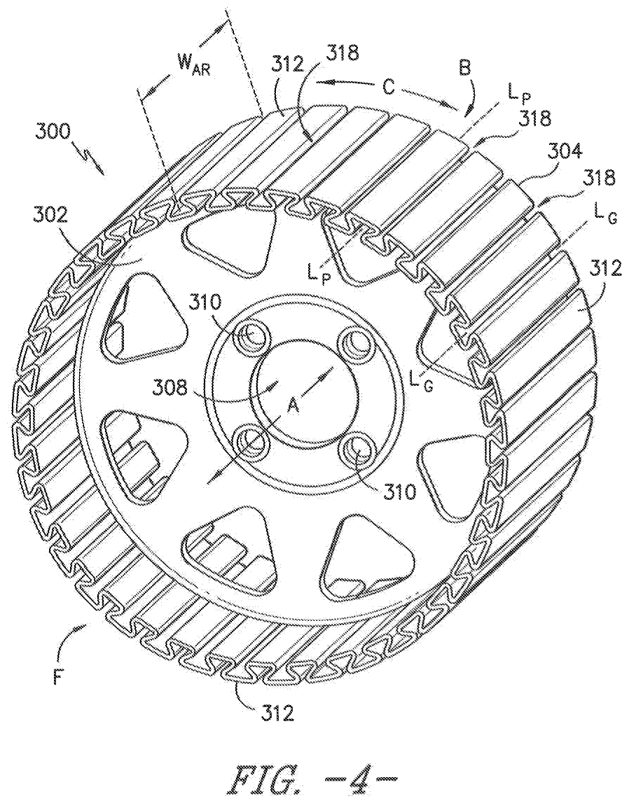

FIGS. 1 and 2 illustrate an exemplary embodiment of a non-pneumatic wheel 100 of the present invention. Wheel 100 includes a non-pneumatic tire 102 supported on a hub 300, which includes an annular receiver 304 with may be connected with a central portion 302. FIG. 3 depicts non-pneumatic tire 102 without hub 300. FIG. 4 depicts annular receiver 304 of hub 300 with central portion 302 in place.

Referring now to FIGS. 1, 2, and 3, non-pneumatic tire 102 includes an annular shear band 104 that extends circumferentially around wheel 100 and has an axial width S_{W}. A plurality of spokes 106 are connected with shear band 102, connected with annular receiver 304 of hub 300, and spaced apart along circumferential direction C as will be further described.

Central portion 302 of hub 300 is configured for supporting wheel 100 on a vehicle. In this exemplary embodiment, huh 300 includes a plurality of spokes or arms 306 extending radially outward from a centroid 308 (FIG. 1) or from the axis of rotation to annular receiver 304. A plurality of openings 310 allow for insertion of fasteners to secure hub 300 (and thereby non-pneumatic wheel 100) to a vehicle. Hub 300 may be e.g., welded to annular receiver 304, formed integrally therewith, or attached using fasteners extending between hub 300 and annular receiver 304. The appearance and features of hub 300, and particularly central portion 302, are provided by way of example only and other configurations may be used as well.

Annular shear band 104 may include one or more reinforcing bands, reinforcing plies, shear layers, and other components (not shown). For example, shear band 104 may be constructed with a radially-inner reinforcing hand, a radially-outer reinforcing band, and a shear layer positioned therebetween. The shear layer may be constructed e.g. of an elastomeric material such as e.g natural and synthetic rubbers, polyurethanes, foamed rubbers and polyurethanes, segmented copolyesters, and block co-polymers of nylon. The reinforcing bands may include reinforcements constructed from e.g., essentially inextensible cord reinforcements embedded in an elastomeric coating. Such reinforcements may include e.g., any of several materials suitable for use as tire belt reinforcements in conventional tires such as cords of steel, composites of glass and resin such as e.g., fiberglass reinforced plastics, and other materials having a high modulus in tension and compression. In still another example, shear band 104 includes reinforcing plies, with each ply including cables that extend substantially along the circumferential direction C and may also be wrapped about axial direction A.

Shear band 102 provides a stiffness that allows spokes 106 to support hub 300 in tension during use of wheel 100 on a vehicle. As wheel 100 rolls across the surface of the ground, hub 300 “hangs” from shear band 102 through a portion of the plurality of spokes 106 that are in tension near the top of wheel 100 opposite the ground contacting portion of shear band 102. The portion of spokes 106 in tension changes as wheel 100 rolls and different spokes move into position opposite the ground contacting portion of shear band 102. At the same time, shear band 102 provides a resiliency or compliance over the ground surface that provides for a smoother, more comfortable ride.

Shear band 102 is depicted in FIGS. 1, 2, and 3, as having a smooth, radially-outer surface 108. However, outer surface 108 may be provided with a tread having e.g., grooves, ribs, blocks, or other features for enhancing traction performance. The tread can be molded directly into outer surface 108 or may be provided as a tread portion wrapped around wheel 100 and attached thereto. Other configurations may be used as well.

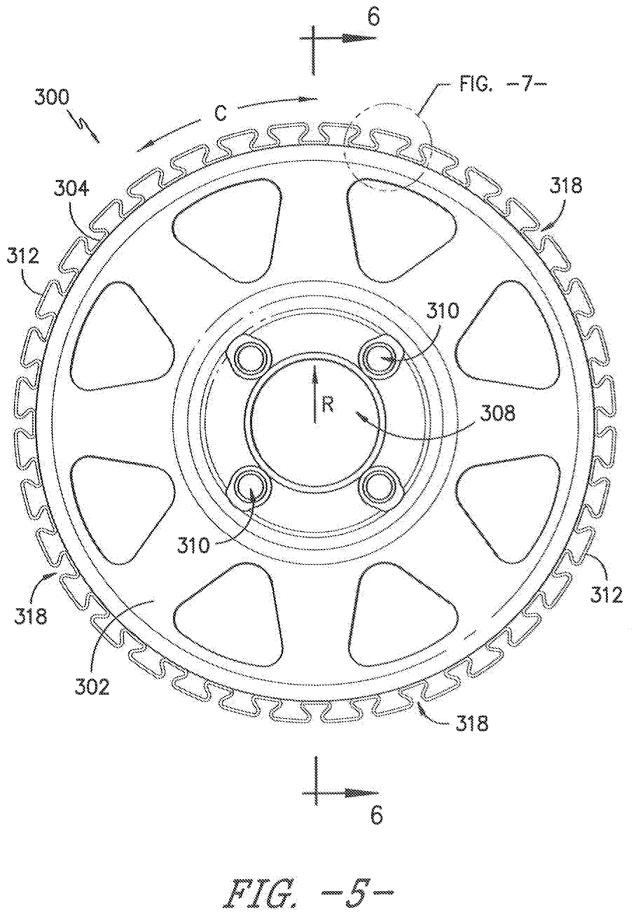

Referring now to FIGS. 4, 5, and 6, annular receiver 304 includes a plurality of grooves 318 spaced apart from each other along circumferential direction C. Each groove 318 defines a longitudinal axis L_{G} extending parallel to axial direction A. Each groove 318 is positioned between a pair of projections 312, which each have a longitudinal axis L_{P} extending parallel to axial direction A. Projections 312 are spaced apart from each other along circumferential direction C by grooves 318, and projections 312 and their spacing from each other define the shape and width of grooves 318.

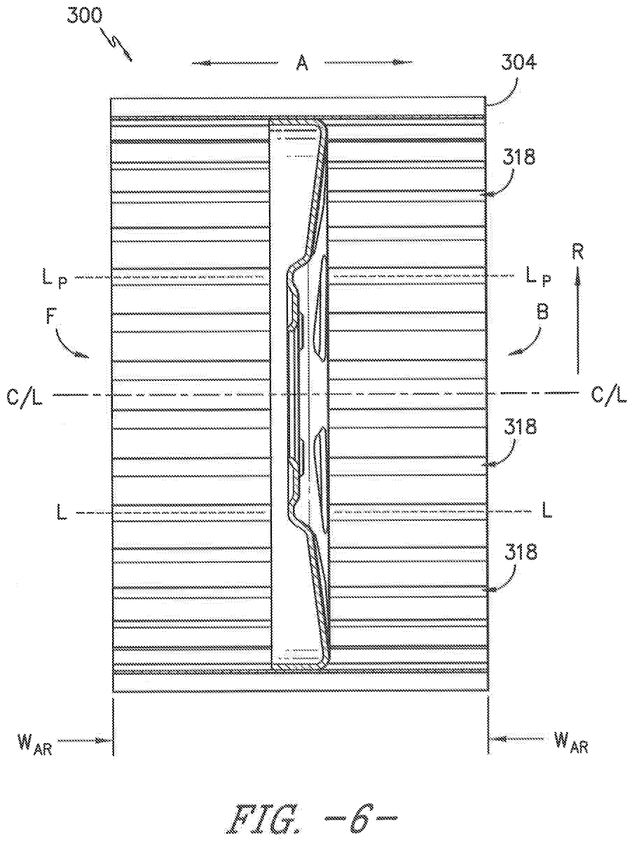

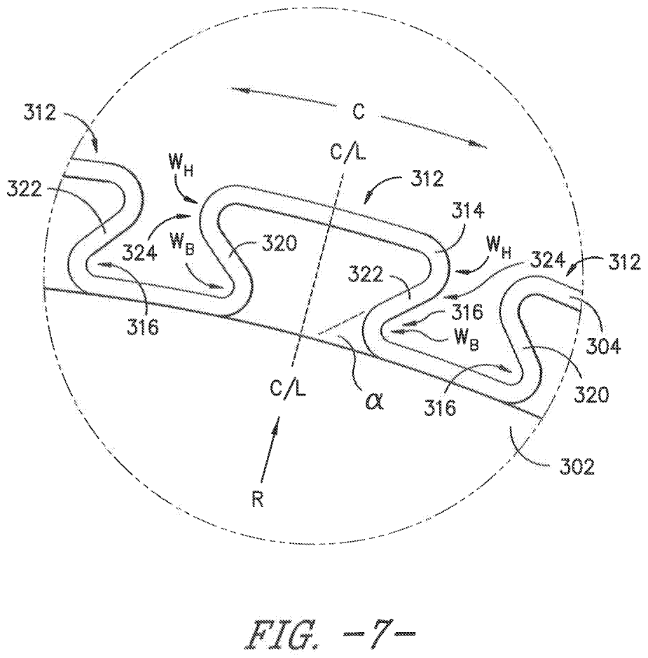

As shown in FIG. 7, for this exemplary embodiment, each projection 312 includes a head 314 positioned radially outward of a base 316. Head 314 has a width W_{H} (FIG. 6) along circumferential direction C that is wider that a width W_{R} along circumferential direction C of base 316. For this exemplary embodiment, width W_{H} and width W_{B} remain constant along axial direction A for the entire axial width W_{AR} of annular receiver 304. Such gives projections 312 and grooves 318 a continuous and uninterrupted profile along axial direction A between opposing sides F and B of annular receiver 304. In addition, each head 314 is located at the same radial distance from the axis of rotation, or centroid 308, of hub 300.

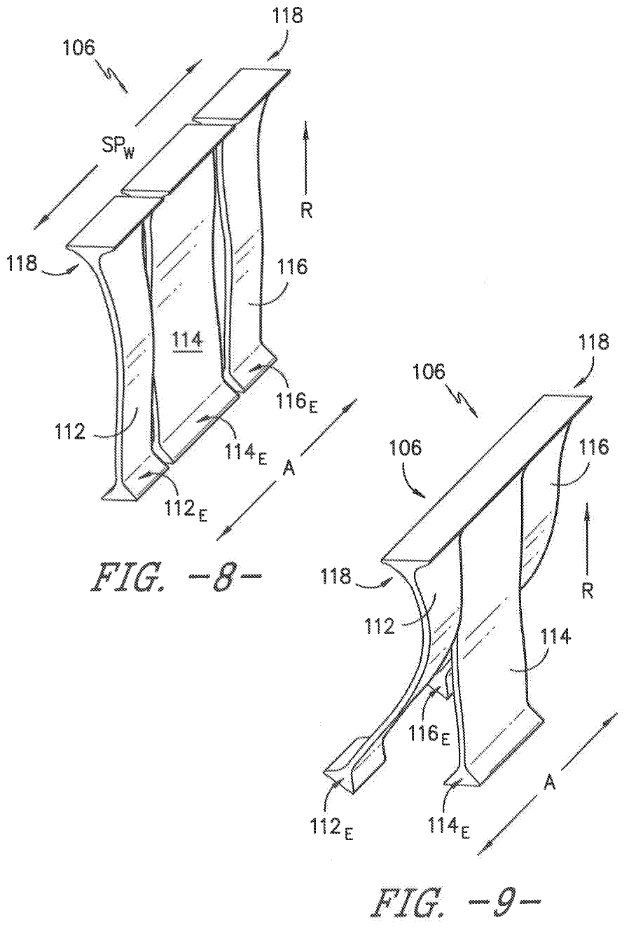

Each projection 312 includes a stem 324 extending between base 316 and head 314 along radial direction R. Stem 324 is formed by a pair of sides 320, 322 that are opposed to each other along circumferential direction C. Each side 320 and 322 forms an acute angle which is in the range of 30 degrees to 60 degrees for this exemplary embodiment. Each projection 312 defines a centerline C/L that is parallel to radial direction R. Each projection 312 is symmetrical about its respective centerline C/L. Viewed along axial direction A as depicted in FIG. 7, sides 320 and 322 are each linear along the direction between base 316 and stem 324. The cross-sectional shape of each groove 318 is configured for complementary receipt of the radially-inner ends 112E, 114E, and 116E (FIGS. 8 and 9) of spokes 106 as will be further described herein.

In one exemplary embodiment, annular receiver 304 is constructed from a single, continuous sheet of metal having axial width W_{AR}. Such sheet may be bent and/or folded to form projections 312 and grooves 318 along circumferential direction. Ends of the sheet are then welded together to create the circular shape of annular receiver 304. Central portion 302 can then be inserted into the interior of annular receiver 304 and welded. thereto (FIG. 6). Other methods of construction may be used as well.

As shown in FIGS. 1, 2, 8, and 9, each spoke 106 includes a radially-outer end 118 that is connected with annular shear band 104. Radially-outer end 118 may be attached directly to shear band 104 or indirectly through a ring or feature connected to shear band 104. Spoke 106 may be one continuous piece along radially-outer end 118 as shown in FIG. 9 or may be separated into three portions as shown in FIG. 8.

In one exemplary embodiment, spoke 106 may include a plurality of reinforcement elements (not shown) provided as inextensible cords extending adjacent and parallel to each other along radial direction R or at other angles to radial direction R. For one exemplary embodiment, as used herein, “inextensible” means the material has an elongation at break of 12 percent or less as measured at 23° C. according to ASTM 885. By way of example, such inextensible cords may be constructed from nylon, steel, combinations thereof, and other materials as well. Such cord may be positioned across the entire axial width SP_{W} (FIG. 8) of spoke 106 or, alternatively, may be positioned across only a portion of width SP_{W}. Such cords may be encased or embedded within one or layers of e.g., polymeric materials such as rubber forming spoke 106. Additional examples of spokes as may be used with the present invention are described in e.g. PCT International Application No. PCT/IB2015/058420, commonly owned by the assignees of the present invention, and incorporated here in its entirety by reference for all purposes.

Referring to FIGS. 8 and 9, for this exemplary embodiment each spoke 106 has a central spoke portion 114 positioned along axial direction A between its pair of corresponding outer spoke portions 112 and 116, which are opposed to each other along axial direction A. Each spoke portion has a respective radially-inner end 112_{E}, 114_{E}, and 116_{E} configured for complementary receipt into grooves 318 of annular receiver 304 Furthermore, radially -inner ends 112_{E}, 114_{E}, and 116_{E} are discrete or separate and may be moved independently of each other. Thus, as shown by way of example in FIG. 9, central portion 114 is shown extending along radial direction R while its associated or corresponding outer portions 112 and 116 may be folded or bent away from radial direction R.

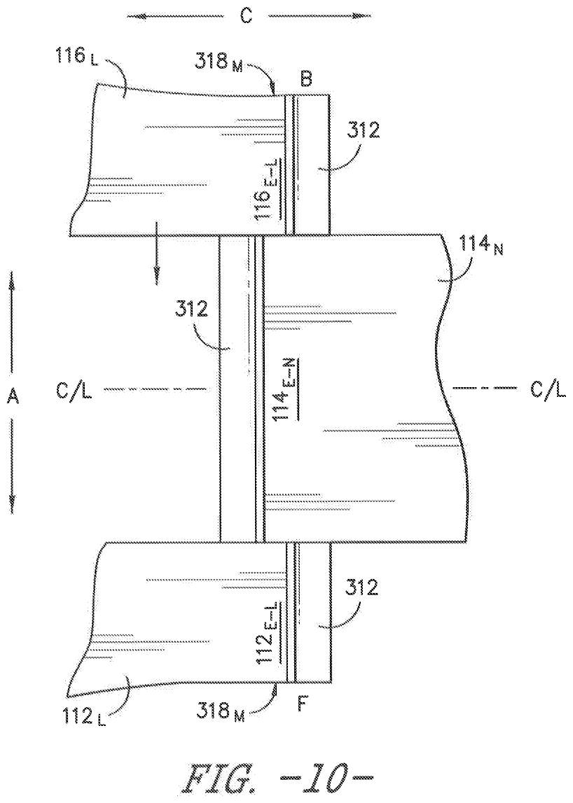

Referring back to FIGS. 1 and 2, which depicts tire 102 assembled with huh 300, central spoke portion 114 of each spoke 106 is not connected into the same groove 318 as its corresponding outer portions 112 and 116. Instead, referring now to FIG. 10, for a given spoke 106_{N}, radially-inner end 114_{E-N} is positioned within groove 318_{M}. The radially-inner ends 112_{N} and 116_{N} (not shown) of spoke 106_{N} are positioned within another groove 318_{N} (not shown) that is circumferentially adjacent to groove 318_{M} along annular receiver 104. Radially-inner ends 112_{L} and 116_{L} from another spoke 106_{L} (circumferentially adjacent to spoke 106_{N}) are also positioned in groove 318_{M}.

Thus, as shown in FIG. 10, moving along axial direction A of groove 318_{M} from front F to hack B, such groove 318 _{M} receives radially-inner end 112_{L} of a first spoke 106_{L}, radially-inner end 114_{N} of a second spoke 106_{N} that is circumferentially adjacent to first spoke 106_{L} along tire 102, and then radially-inner end 116_{L} of first poke 106_{L}.

As such, as shown in FIGS. 1 and 2, central spoke portions 114 form an angle β with outer spoke portions 112 and 116 when wheel 100 is assembled. For this exemplary embodiment, angle β is in the range of 5 degrees≤β≤15 degrees or, in still another embodiment, angle β is 10 degrees.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would he readily apparent to one of ordinary skill in the art.

What is claimed is:

1. A hub for a non-pneumatic wheel having a plurality of spokes, the hub defining axial, radial, and circumferential directions, the hub comprising:
a central portion configured for supporting the wheel on a vehicle;
an annular receiver supported on the central portion and extending circumferentially around the central portion, the annular receiver comprising
a plurality of projections spaced apart from each other along the circumferential direction, each projection having a longitudinal axis extending along the axial direction; and
a plurality of grooves spaced apart from each other along the circumferential direction, each groove positioned between a pair of the plurality of projections, each groove having a longitudinal axis extending along the axial direction, each groove configured for the receipt of at least one radially-inner end of one or more of spokes.

2. The hub for a non-pneumatic wheel as in claim 1, wherein each projection comprises a head positioned radially-outward of a base, wherein the head has width along the circumferential direction that is wider than a width along the circumferential direction of the base.

3. The hub for a non-pneumatic wheel as in claim 2, wherein the stem of each projection comprises a pair of sides opposed to each other along the circumferential direction with each side extending from the base to the head of the projection.

4. The hub for a non-pneumatic wheel as in claim 2, wherein each side forms an angle in the range of 30 degrees to 60 degrees from the radial direction.

5. The hub for a non-pneumatic wheel as in claim 2, wherein each projection defines a centerline parallel to the radial direction, and wherein each projection is symmetrical about its centerline.

6. The hub for a non-pneumatic wheel as in claim 1, wherein the hub has a pair of opposing sides separated from each other along the axial direction, and wherein each projection maintains a continuous profile along the axial direction between the opposing sides.

7. The hub for a non-pneumatic wheel as in claim 6, wherein each groove maintains a continuous profile along the axial direction between the opposing sides.

8. The hub for a non-pneumatic wheel as in claim 1, wherein the spokes each have a least one radially inner end, and wherein each groove has a shape along the axial direction that is configured for complementary receipt of the radially inner end of one or more of the spokes.

9. The hub for a non-pneumatic wheel as in claim 1, wherein the annular receiver comprises a single sheet of metal extending about the circumferential direction and forming the plurality of grooves and the plurality of projections.

10. The hub for a non-pneumatic wheel as in claim 1, wherein the annular receiver comprises a single sheet of metal extending about the circumferential direction and rolled to form the plurality of grooves and the plurality of projections.

11. The hub for a non-pneumatic wheel as in claim 1, wherein the annular receiver is attached to the central portion.

12. The hub for a non-pneumatic wheel as in claim 12, wherein the annular receiver is welded to the central portion.

13. The hub for a non-pneumatic wheel as in claim 1, wherein the longitudinal axis of each projection is parallel to the axial direction.

14. The hub for a non-pneumatic wheel as in claim 1, wherein the longitudinal axes of the projections are parallel to one another.

15. The hub for a non-pneumatic wheel as in claim 1, wherein the central portion defined a centroid and further comprises a plurality of arms extending radially outward from the centroid to the receiver.

16. A non-pneumatic wheel comprising the hub of claim 1.
